(19) United States
(12) Patent Application Publication
(10) Pub. No.: US 2017/0324280 A1
(43) Pub. Date: Nov. 9, 2017

(54) WIRELESS POWER SUPPLY DEVICE, WIRELESS POWER RECEIVING DEVICE AND WIRELESS POWER TRANSMISSION SYSTEM

(71) Applicant: MINEBEA MITSUMI INC., Kitasaku-gun (JP)

(72) Inventor: Shinichi SUZUKI, Hamamatsu-shi (JP)

(73) Assignee: MINEBEA MITSUMI INC., Kitasaku-gun (JP)

(21) Appl. No.: 15/484,784

(22) Filed: Apr. 11, 2017

(30) Foreign Application Priority Data
May 6, 2016 (JP) 2016-092981

(51) Int. Cl. H02J 50/12; H02J 50/90; H02J 50/15; H04B 5/00

(52) U.S. Cl. CPC H02J 50/12; H04B 5/0037; H02J 50/90; H02J 50/15

(57) ABSTRACT

A wireless power supply device includes: a power supply coil for wirelessly transmitting electric power to a power receiving device; a driving circuit for outputting pulse electric power to the power supply coil; a first radio module for receiving rectified voltage information regarding rectified voltage generated in the power receiving device via a radio communication path; and a control circuit for generating a driving control signal on the basis of the rectified voltage information received by the first radio module, thereby to control the driving circuit, said control circuit controlling a driving frequency of the driving circuit at a fixed frequency between a series resonant frequency and a parallel resonant frequency of a resonant circuit of the power receiving device.

### CROSS REFERENCE TO RELATED APPLICATIONS

This application claims the benefit of Japanese Patent Application No. 2016-092981, filed May 6, 2016, which is hereby incorporated by reference in its entirety.

### BACKGROUND

### Technical Field

The present disclosure relates to a wireless power supply device, a wireless power receiving device and a wireless power transmission system.

### Background

In recent times, a wireless power transmission technology for transmitting power without using a metal contact and a connector has been adopted for use in a greater amount of appliances. The wireless power transmission is also called wireless power supply and non-contact power transmission.

This wireless power transmission is mainly classified into a system of supplying power by converting electric power to an electromagnetic wave (microwave), a system of utilizing a resonant phenomenon of electric field coupling, and a system based on magnetic field coupling. The type of utilizing a resonant phenomenon of a magnetic field based on magnetic field coupling is, for example, the invention according to Japanese Patent Laid-Open No. 2011-139621.

As a means for solving the present problems, Abstract of Japanese Patent Laid-Open No. 2011-139621 reads: “Electric power is transmitted by magnetic resonance from a power supply coil L2 to a power receiving coil L3. VCO 202 alternately turns on and off a switching transistor Q1 and a switching transistor Q2 at a driving frequency fo, supplies AC power to the power supply coil L2, and supplies AC power from the power supply coil L2 to the power receiving coil L3. A phase detection circuit 114 detects a phase difference between a current phase and a voltage phase, and VCO 202 adjusts the driving frequency fo, so that this phase difference becomes zero. When a load voltage changes, a detection value of the current phase is adjusted and, as a result, the driving frequency fo is adjusted”.

### SUMMARY

In the system of the magnetic field resonance type described in Japanese Patent Laid-Open No. 2011-139621, power supply side resonance and power receiving side resonance need to coincide with each other. Therefore, though the resonant frequency is controlled, in some cases, it is difficult to make the frequency follow deviations of the positions and variations of the distance of the power supply coil and the power receiving coil.

At the present, the object of the present disclosure is to dispense with control of a resonance frequency by means of a simple circuit configuration in a wireless power supply device, a wireless power receiving device and a wireless power transmission system.

In order to solve the above-mentioned problem, the wireless power supply device according to the present disclosure comprises a power supply coil for wirelessly transmitting electric power (electric power transmission) to the power receiving device, a driving circuit for outputting pulse electric power for driving to the power supply coil, a first radio module for receiving rectified voltage information about rectified voltage in the power receiving device via a radio communication path, and a control circuit for generating a driving control signal on the basis of the rectified voltage information received by the first radio module, thereby to control the driving circuit. The control circuit controls a driving frequency of the driving circuit at a fixed frequency between a series resonant frequency and a parallel resonant frequency of the resonant circuit of the power receiving device.

The other means will be explained in connection with embodiments.

According to the present disclosure, a wireless power supply device, a wireless power receiving device and a wireless power transmission system can be configured as simple circuits, and control of a resonant frequency becomes unnecessary.

### BRIEF DESCRIPTION OF THE DRAWINGS

FIG. 1 is a configuration diagram showing the outline of the wireless power transmission system in the embodiment.

FIG. 2 shows an equivalent circuit of a magnetic field coupling circuit seen from the wireless power receiving device.

FIG. 3 shows configuration of a control circuit.

FIG. 4 is a waveform diagram for explaining operation of a control circuit.

FIG. 5 is a flowchart showing operation performed until communication of a radio module is established.

FIG. 6 is a flowchart showing operation of electric power adjustment.

FIG. 7 is a flowchart showing operation at the time of output voltage abnormality.

FIG. 8 is a flowchart showing operation in a case where an error occurs in establishing communication path between radio modules.

FIG. 9 is a flowchart showing control operation of a DC/DC converter.

FIG. 10 is a sequence diagram showing operation from starting to electric power adjustment.

FIG. 11 is a sequence diagram showing control operation of a DC/DC converter from a upper device.

FIG. 12 is a sequence diagram showing operation at the time of occurrence of an error.

### DETAILED DESCRIPTION

An embodiment of the present disclosure will be explained in detail below by referring to each diagram.

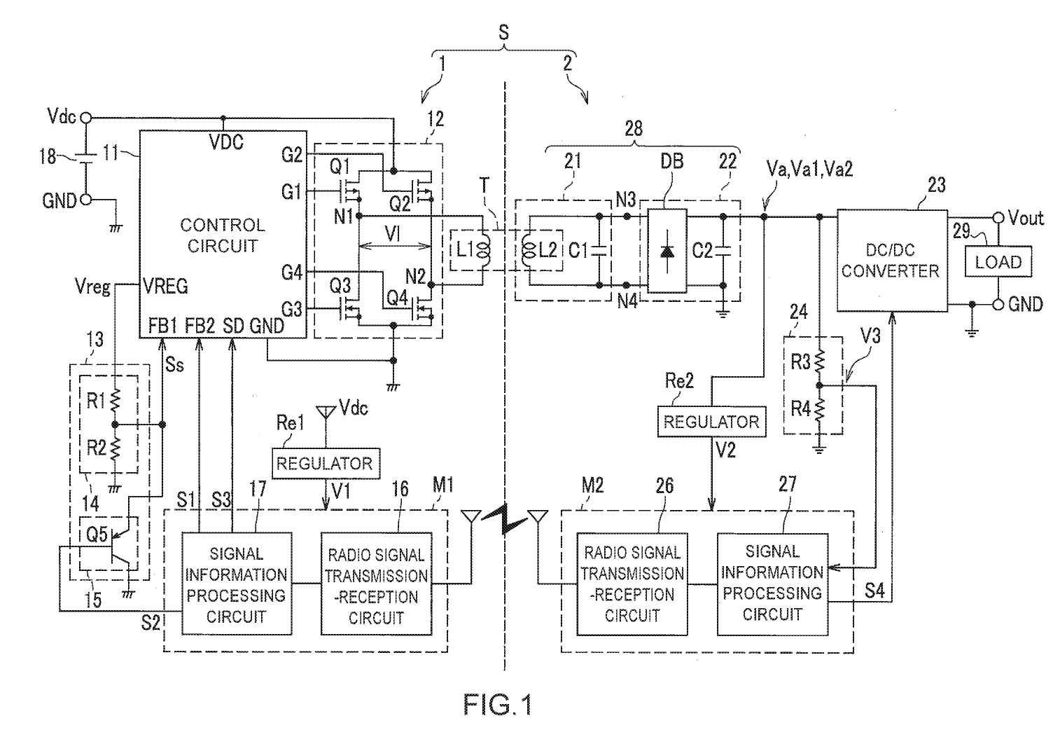

FIG. 1 is a configuration diagram showing the outline of the wireless power transmission system S in the embodiment.

The wireless power transmission system S is a system in which a wireless power supply device 1 transmits electric power to a wireless power receiving device 2 by means of magnetic field coupling. Hereinafter, the configurations of the power supply side and the power receiving side will be explained.

The power supply device 1 as the power supply side is configured to include a DC power supply 18, a control circuit 11, a driving circuit 12 having a full-bridge configuration, a power supply coil L1, an initial voltage control circuit 13, a first radio module M1, and a regulator Re1.

The control circuit 11 controls the driving circuit 12 by generating gate signals G1 to G4 on the basis of signals output by the initial voltage control circuit 13 and by the first radio module M1. The gate signals G1 to G4 are driving control signals for controlling the driving circuit 12. A power supply terminal VDC of this control circuit 11 is connected to the DC power supply 18, and a DC voltage Vdc is applied so that the control circuit 11 operates. Further, the control circuit 11 applies a predetermined constant voltage Vreg from a constant voltage terminal VREG to the initial voltage control circuit 13. This control circuit 11 generates the gate signals G1 to G4 on the basis of the rectifyied voltage information received by the first radio module M1, so that an on-duty of pulse electric power is variably controlled, and controls the driving circuit 12.

The driving circuit 12 is, for example, a full-bridge circuit comprising a PMOS (Q1, Q2) and an NMOS (Q3, Q4) and outputs pulse electric power to the power supply coil L1 for driving at a resonance frequency on the side of the wireless power receiving device 2. A node N1 connects the PMOS (Q1) to the NMOS (Q3). A node N2 connects the PMOS (Q2) to the NMOS (Q4). To the nodes N1 and N2, the power supply coil L1 is connected.

This control circuit 12 is connected to the DC power supply 18 and supplied with DC voltage Vdc so that the driving circuit 12 operates. The power supply coil L1 transmits electric power to a power receiving coil L2 of the wireless power receiving device 2 by magnetic field coupling. The driving circuit 12 may comprise NMOSs only.

The initial voltage control circuit 13 comprises an initial voltage setting circuit 14 for setting first predetermined voltage Va1 and an initial voltage setting release circuit 15 for releasing setting of the initial voltage. Concretely, the initial voltage setting circuit 14 is configured to include voltage dividing resistances R1 and R2. The initial voltage setting release circuit 15 is configured to include a transistor Q5 and has a function of dropping a node of the initial voltage to a potential of the ground. This initial voltage control circuit 13 operates with a predetermined constant voltage Vreg applied thereto from a constant voltage terminal VREG of the control circuit 11, and outputs an initial driving control signal Ss to a terminal FB1. The control circuit 11 sets an initial value of an on-duty of the gate signals G1 to G4 on the basis of the initial driving control signal Ss. Then, a secondary power supply part 28 of the wireless power receiving device 2 described later supplies first predetermined voltage Va1 (for example 5V), which allows a second radio module M2 to operate.

The first radio module M1 is configured to include a radio signal transmission-reception circuit 16 and a signal information processing circuit 17. The radio signal transmission-reception circuit 16 has a function of transmitting and receiving a signal via a radio communication path (one example of a radio path) between the circuit 16 and a radio signal transmission-reception circuit 26 of the wireless power receiving device 2. Both an electric field intensity of the radio signal transmission-reception circuit 16 and an electric field intensity of the below-described radio signal transmission-reception circuit 26 are at most 35 μV/m.

The communication between the radio signal transmission-reception circuit 16 and the radio signal transmission-reception circuit 26 is not limited to electric wave communication, and may be radio communication such as visible light communication, infrared communication, and ultrasonic communication, while no limitation is imposed on this communication.

The signal information processing circuit 17 is a microcomputer provided with, for example, a storage part and a processor. It also executes a non-illustrated power supply control program to control the control circuit 11 and the initial voltage setting release circuit 15. Concretely, the signal information processing circuit 17 outputs a control signal (first control signal) S1 to a terminal FB2 of the control circuit 11 to feedback-control electric power supplied to the power receiving side. Further, the signal information processing circuit 17 outputs a control signal (second control signal) S2 to a base of the transistor Q5 of the initial voltage setting release circuit 15, thereby to turn on the transistor Q5 and set the initial driving control signal Ss to 0V. Moreover, the signal information processing circuit 17 outputs a control signal (third control signal) S3 to a terminal SD, thereby to shut down the control circuit 11.

This first radio module M1 operates by electric power of driving voltage V1 (e.g. 3.3V) supplied from a regulator Re1. The regulator Re1, to which a DC voltage Vdc is applied, supplies electric power of driving voltage V1.

The wireless power supply device 2 as the power receiving side is configured to include a resonant circuit 21, a rectifying circuit 22, a DC/DC converter (DC conversion circuit; one example of a load) 23, a rectified voltage detection circuit 24, a second radio module (one example of a second radio module) M2, and a regulator Re2.

The resonant circuit 21 is an LC resonant circuit, in which a power receiving coil L2 and a resonant capacitor C1 are connected in parallel. This resonant circuit 21 receives electric power (=power reception) by magnetic field coupling from the power supply coil L1 of the wireless power supply device 1, thereby to generate resonant voltage. The resonant circuit 21 is connected to the rectifying circuit 22 via the nodes N3 and N4. A transformer T shown by the broken line consists of the power supply coil L1 and the power receiving coil L2.

The rectifying circuit 22 is configured to include a diode bridge DB for rectifying an input alternating current to a direct current and a rectifying capacitor C2 for smoothing rectified voltage. In this manner, electric power of rectified voltage Va is output to be supplied to the DC/DC converter 23, the rectified voltage detection circuit 24 and the regulator Re2. The secondary power supply part 28 is configured to include the resonant circuit 21 and the rectifying circuit 22.

This second radio module M2 is configured to include the radio signal transmission-reception circuit 26 and the signal information processing circuit 27, and operates by electric power of driving voltage V2 (e.g. 3.3V) supplied from a regulator Re2.

The radio signal transmission-reception circuit 26 has a function of transmitting and receiving a signal via a radio communication path between the circuit 26 and the wireless power supply device 1. The signal information processing circuit 27 is a microcomputer provided with, for example, a storage part and a processor. The signal information processing circuit 27 carries out a non-illustrated power receiving control program, measures detection voltage V3 of a rectified voltage detection circuit 24 to generate a detection signal (rectified voltage information) Sv and transmits this detection signal Sv to the wireless power supply device 1 by the radio signal transmission-reception circuit 26. Moreover, the signal information processing circuit 27 outputs a control signal S4 to the DC/DC converter 23 to activate or deactivate this DC/DC converter 23.

When electric power of second predetermined voltage Va2 (e.g. 12V) is supplied to the DC/DC converter 23 from the secondary power supply part 28, the DC/DC converter 23 acts as a circuit for converting the electric power to electric power of other output voltage Vout. The load 29 is driven by the output voltage Vout of the DC/DC converter 23. The DC/DC converter 23 and the load 29 correspond to loads in this wireless power receiving device 2. This DC/DC converter 23 activates or deactivates on the basis of a control signal (fourth control signal) S4 output from the second radio module M2.

The rectified voltage detection circuit 24 is configured to include the voltage dividing resistors R3 and R4 as well as applies detection voltage V3 obtained by performing voltage division on the rectified voltage Va to the signal information processing circuit 27 of the second radio module M2.

This second radio module M2 operates by electric power of driving voltage V2 (e.g. 3.3V) supplied from a regulator Re2. The regulator Re2 to which rectified voltage Va is applied supplies electric power of driving voltage V2.

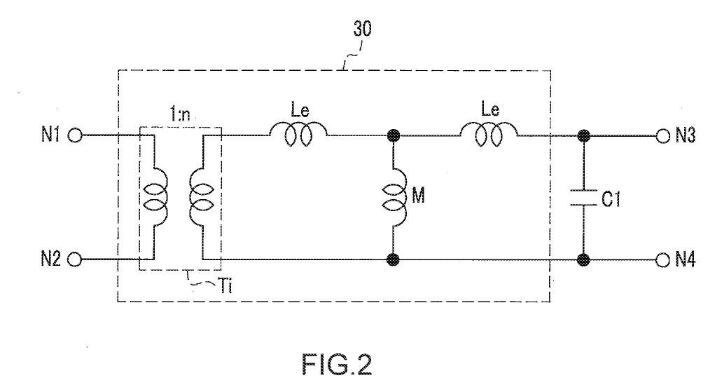

FIG. 2 shows an equivalent circuit 30 of a magnetic field coupling circuit seen from the wireless power receiving device 2.

When the transformer T (see FIG. 1) consisting of the power supply coil L1 and the power receiving coil L2 is illustrated as the equivalent circuit 30, the equivalent circuit 30 consists of an ideal transformer Ti, two leakage inductances Le and a mutual inductance M. This ideal transformer Ti has a winding ratio of the primary side to the secondary side, which is 1:N. It is assumed that the primary side of the ideal transformer Ti is expected to be connected to the respective nodes N1 and N2. One end of the secondary side of the ideal transformer Ti is connected to one end of the resonant capacitor C1 and the node N3 via the two leakage inductances Le. The other end of the secondary side of the ideal transformer Ti is connected to the other end of the resonant capacitor C1 and the node N4. The mutual inductance M is connected between the connection point of the two leakage inductances Le and the other end of the secondary side of the ideal transformer Ti.

Then, the connection coefficient k of the transformer T consisting of the power supply coil L1 and the power receiving coil L2 shown in the equivalent circuit 30 is determined by the following formula (1).

$$k = \sqrt{\frac{( {l}_{2} - {L}_{s} )}{{l}_{2}}} \qquad ( 1 )$$

where Lₛ: inductance at the time of short-circuiting on the power supply side I₂: self-inductance of L2

Further, the leakage inductance Le is determined by the following formula (2).

Lₑ=(1−k)×I₂ (2)

A self-inductance I₂ of the power receiving coil L2 is expressed by the following formula (3).

I₂=M+Lₑ (3)

where M: mutual inductance

Then, the series resonant frequency fs of the wireless power receiving device 2 is determined by the following formula (4).

$${f}_{s} = \frac{1}{2 π \sqrt{2 \times {L}_{e} \times {C}_{1}}} \qquad ( 4 )$$

where C₁: capacitance of the resonant capacitor.

The parallel resonant frequency fp of the wireless power receiving device 2 is determined by the following formula (5).

$${f}_{p} = \frac{1}{2 π \sqrt{( M + {L}_{e} ) \times {C}_{1}}} = \frac{1}{2 π \sqrt{{l}_{2} \times {C}_{1}}} \qquad ( 5 )$$

As clarified by the formula (4), the series resonant frequency fs is determined by the leakage inductance Le and the capacitance C₁ of the resonant capacitor. As clarified by the formula (5), the parallel resonant frequency fp is determined by the self-inductance I₂ of the power receiving coil L2 and the capacitance C₁ of the resonant capacitor.

As clarified by the formula (2), when the distance between the power supply coil L1 and the power receiving coil L2 of the magnetic field coupling circuit changes, the coupling coefficient k changes and therefore the leakage inductance Le changes. Thus, as clarified by the formula (4), the series resonant frequency fs of the wireless power receiving device 2 varies depending on the distance.

However, as represented by the formula (3), the self-inductance I₂ of the power receiving coil L2 is equal to the sum of the mutual inductance M and the leakage inductance Le. When the leakage inductance Le becomes larger, the mutual inductance M becomes smaller and thus their sum is constant. Therefore, as clarified by the formula (5), the parallel resonant frequency fp of the wireless power receiving device 2 is constant, irrespective of the distance.

At a predetermined distance between the power supply coil L1 and the power receiving coil L2, the resonant frequencies of the wireless power receiving device 2 are the series resonant frequency fs and the parallel resonance frequency fp. The power supply coil L1 is spaced from the power receiving coil L2, so that the coupling coefficient k becomes smaller, and therefore the gap between the series resonant frequency fs and the parallel resonant frequency fp is narrowed.

The coupling coefficient k of the transformer T consisting of the power supply coil L1 and the power receiving coil L2 is small, so that the leakage inductance Le of the power receiving coil L2 becomes larger. Accordingly, the series resonant frequency fs by the two leakage inductances Le and the resonant capacitor C1 is approximate to the parallel resonant frequency fp by the self-inductance I₂ of the power receiving coil L2 and the resonant capacitor C1. The control circuit 11 (see FIG. 1) pulse-drives the power supply coil L1 at a fixed frequency between the parallel resonant frequency fp and the series resonant frequency fs, so that electric power can be transmitted efficiently without controlling the resonant frequency.

In the present embodiment, the resonant frequency of the wireless power receiving device 2 is set (fixed) to a frequency between the series resonant frequency fs and the parallel resonant frequency fp of the power receiving side. Due to this, even if the distance between the power supply coil L1 and the power receiving coil L2 varies more or less, electric power can be efficiently transmitted from the wireless power supply device 1 to the wireless power receiving device 2. Further, even if the driving frequency of the wireless power supply device 1 varies due to component variations, electric power can be efficiently transmitted.

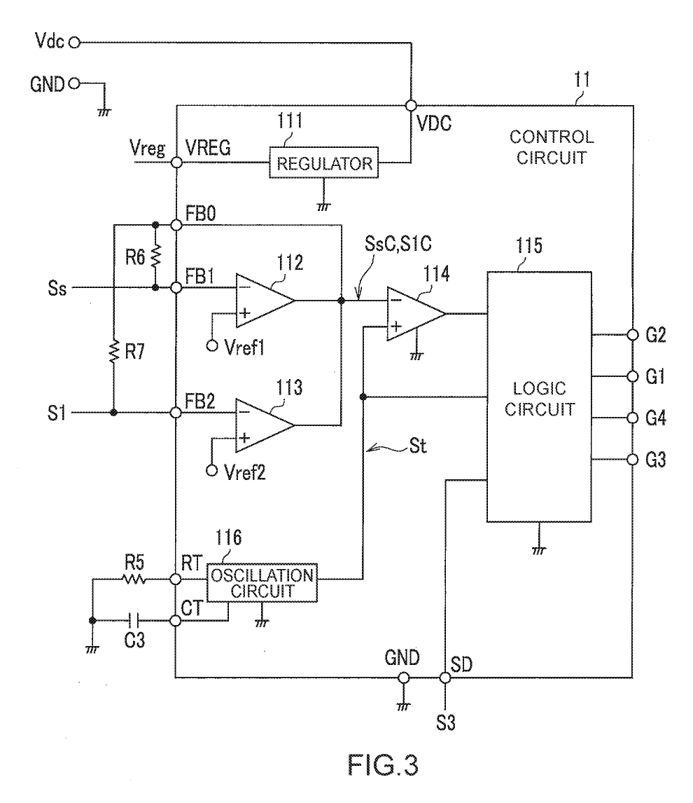

FIG. 3 shows the configuration of the control circuit 11.

The control circuit 11 is configured to include a regulator 111, operational amplifiers 112, 113, a comparator 114, a logic circuit 115 and an oscillation circuit 116. This control circuit 11 includes a power supply terminal VDC, a ground terminal GND, a constant voltage terminal VREG outputting constant voltage Vreg, inversion input terminals FB1, FB2 and a terminal SD on the input side, an output terminal FB0, terminals RT, CT for setting a frequency of the oscillation circuit 116, and terminals G1, G2, G3, G4 on the output side.

DC voltage Vdc is applied to the power supply terminal VDC, and the ground terminal GND is connected to the ground.

The regulator 111 generates the constant voltage Vreg and is connected to the power supply terminal VDC and the ground terminal GND, thereby to output, to the constant voltage terminal VREG, the constant voltage Vreg generated from the DC voltage Vdc.

A resistor R6 is connected between the inversion input terminal FB1 and the output terminal FB0 of the operational amplifier 112. When the initial driving control signal Ss is input to the inversion input terminal FB1 from the initial voltage setting circuit 14 of the initial voltage control circuit 13, the operational amplifier 112 outputs an output signal ScC depending on a potential difference between a reference voltage Vref1 and the initial driving control signal Ss.

A resistor R7 is connected between the inversion input terminal FB2 and the output terminal FB0 of the operational amplifier 113. When a control signal S1 is input to the inversion input terminal FB2 from the signal information processing circuit 17 of the first radio module M1, the operational amplifier 113 outputs an output signal S1C depending on a potential difference between a reference voltage Vref2 and the control signal S1.

To an inversion input terminal of the comparator 114, the output terminals FB0 of these operational amplifiers 112 and 113 are connected and the one with lower voltage of the output signals SsC and S1C is input, while a triangular wave signal St of the oscillation circuit 116 is input to a non-inversion input terminal. In this manner, it is possible to generate and an on-duty pulse signal depending on the voltage applied to the inversion input terminal.

The logic circuit 115 has its input side connected to an output terminal of the comparator 114, the triangular wave signal St and the terminal SD, while having its output side connected to an output terminal of the gate signal. This logic circuit 115 generates the gate signals G1, G2 and the gate signals G3, G4 respectively from an uppermost peak and a lowermost peak of the triangular wave signal St as well as a falling pulse signal input from the comparator 114. When a control signal S3 is input to the terminal SD from the signal information processing circuit 17 of the first radio module M1, the logic circuit 115 stops output operation of the gate signals G1 to G4.

While the resistor R5 is connected to the terminal RT and the capacitor C3 is connected to the terminal CT, the oscillation circuit 116 oscillates to output a triangular wave.

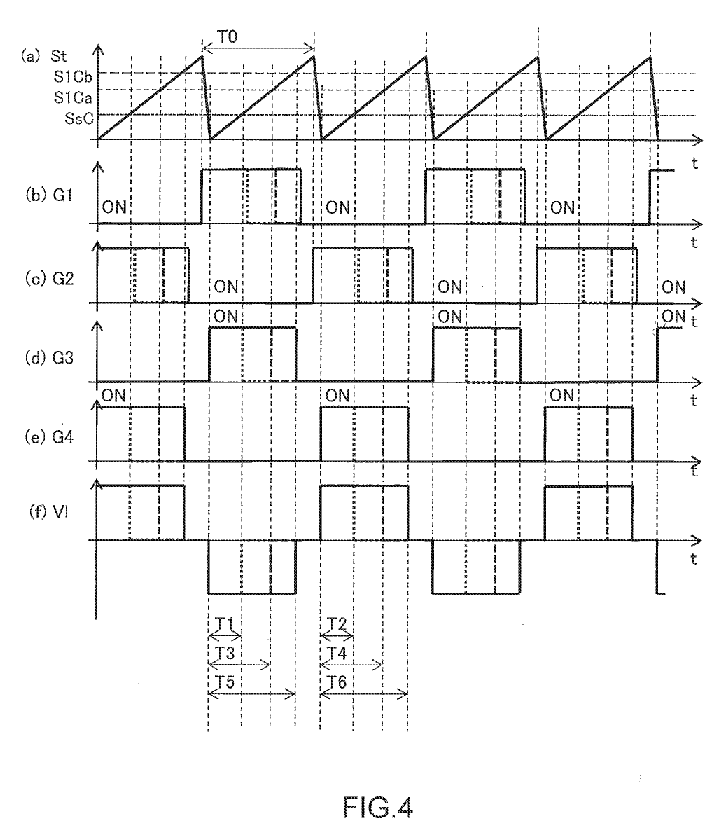

FIGS. 4(a) to 4(f) are waveform diagrams for explaining operation of the control circuit 11, and the horizontal axes of the respective waveform diagrams indicate the common time.

FIG. 4(a) shows a waveform of the triangular wave signal St output from the oscillation circuit 116 and input to the non-inversion input terminal of the comparator 114. The triangular wave signal St always repeats a ramp waveform with a period T0. This period T0 is set in such a manner that, when this period is doubled and its reciprocal is calculated, it becomes the resonant frequency on the power receiving side. The shortest dash line in the horizontal line of FIG. 4(a) indicates voltage of the output signal SsC of the operational amplifier 112 immediately after starting. The voltage of the output signal SsC is applied to the inversion input terminal of the comparator 114. Then, the rectified voltage Va output from the rectifying circuit 22 becomes first predetermined voltage Va1 (e.g. 5V).

The second longest dash line in the horizontal line indicates voltage of an output signal S1Ca of the operational amplifier 113 in case of e.g. a light load. The voltage of the output signal S1Ca is applied to the inversion input terminal of the comparator 114.

The longest dash line in the horizontal line indicates voltage of an output signal S1Cb of the operational amplifier 113 in case of a heavy load. The voltage of the output signal S1Cb is applied to the inversion input terminal of the comparator 114. Then, the rectified voltage Va output from the rectifying circuit 22 becomes second predetermined voltage Va2 (e.g. 12V).

FIG. 4(b) shows a waveform of the gate signal G1.

The shorter dash line indicates the gate signal G1 immediately after starting. The longer dash line indicates the gate signal G1 in case of e.g. a light load. The solid line indicates the gate signal G1 in case of a heavy load. The gate signal G1 rises once every two of the upper limit peaks of the triangular wave signal St, and the gate signal G1 falls after a prescribed time has elapsed since the triangular wave signal St exceeded the voltage of the inversion input terminal of the comparator 114. When this gate signal G1 is at a low level, PMOS (Q1) is turned on.

FIG. 4(c) shows a waveform of the gate signal G2.

The shorter dash line indicates the gate signal G2 immediately after starting. The longer dash line indicates the gate signal G2 in case of e.g. a light load. The solid line indicates the gate signal G2 in case of a heavy load. The gate signal G2 rises once every two of the upper limit peaks of the triangular wave signal St, and the gate signal G2 falls after a prescribed time has elapsed since the triangular wave signal St exceeds the voltage of the inversion input terminal of the comparator 114. When this gate signal G2 is at a low level, PMOS (Q2) is turned on.

FIG. 4(d) shows a waveform of the gate signal G3.

The shorter dash line indicates the gate signal G3 immediately after starting. The longer dash line indicates the gate signal G3 in case of e.g. a light load. The solid line indicates the gate signal G3 in case of a heavy load. The gate signal G3 rises once every two of the lower limit peaks of the triangular wave signal St, and the gate signal G3 falls when the triangular wave signal St exceeds the voltage of the inversion input terminal of the comparator 114. When this gate signal G3 is at a high level, NMOS (Q3) is turned on.

FIG. 4(e) shows a waveform of the gate signal G4.

The shorter dash line indicates the gate signal G4 immediately after starting. The longer dash line indicates the gate signal G4 in case of e.g. a light load. The solid line indicates the gate signal G4 in case of a heavy load. The gate signal G4 rises once every two of the lower limit peaks of the triangular wave signal St, and the gate signal G4 falls when the triangular wave signal St exceeds the voltage of the inversion input terminal of the comparator 114. When this gate signal G4 is at a high level, NMOS (Q4) is turned on.

FIG. 4(f) shows a waveform of a coil voltage VI applied to the power supply coil L1.

This coil voltage VI assumes a waveform, in which a positive pulse, zero voltage and a negative pulse are periodically repeated. The shorter dash line indicates the coil voltage VI immediately after starting. The longer dash line indicates the coil voltage VI in case of e.g. a light load. The solid line indicates the coil voltage VI in case of a heavy load. If the gate signal G1 is at a low level and the gate signal G4 is at a high level, the coil voltage VI is a positive pulse. If the gate signal G2 is at a low level and the gate signal G3 is at a high level, the coil voltage VI becomes a negative pulse.

The shorter dash line indicates the coil voltage VI immediately after starting. The coil voltage VI outputs a negative pulse over the period T1 and becomes zero voltage, while it outputs a positive pulse over the period T2 and becomes zero voltage, so that this is repeated. The periods T1 and T2 are equal to each other.

The longer dash line indicates the coil voltage VI in case of e.g. a light load. The coil voltage VI outputs a negative pulse over the period T3 and becomes zero voltage, while it outputs a positive pulse over the period T4 and becomes zero voltage, so that this is repeated. The periods T3 and T4 are equal to each other.

The solid line indicates the coil voltage VI in case of a heavy load. The coil voltage VI outputs a negative pulse over the period T5 and becomes zero voltage, while it outputs a positive pulse over the period T6 and becomes zero voltage, so that this is repeated. The periods T5 and T6 are equal to each other. As described above, the control circuit 11 generates the gate signals G1 to G4 with a resonant frequency and a predetermined on-duty signal on the power receiving side, thereby to control the driving circuit 12. In this manner, the wireless power transmission system S can be configured by means of a simple circuit and control of a resonant frequency becomes unnecessary.

As shown in FIG. 4(f), the waveform of the coil voltage VI is output with symmetry of a positive pulse and a negative pulse maintained. In this manner, resonant voltage generated in the resonant circuit 21 on the power receiving side can have symmetry.

(Explanation about Operation)

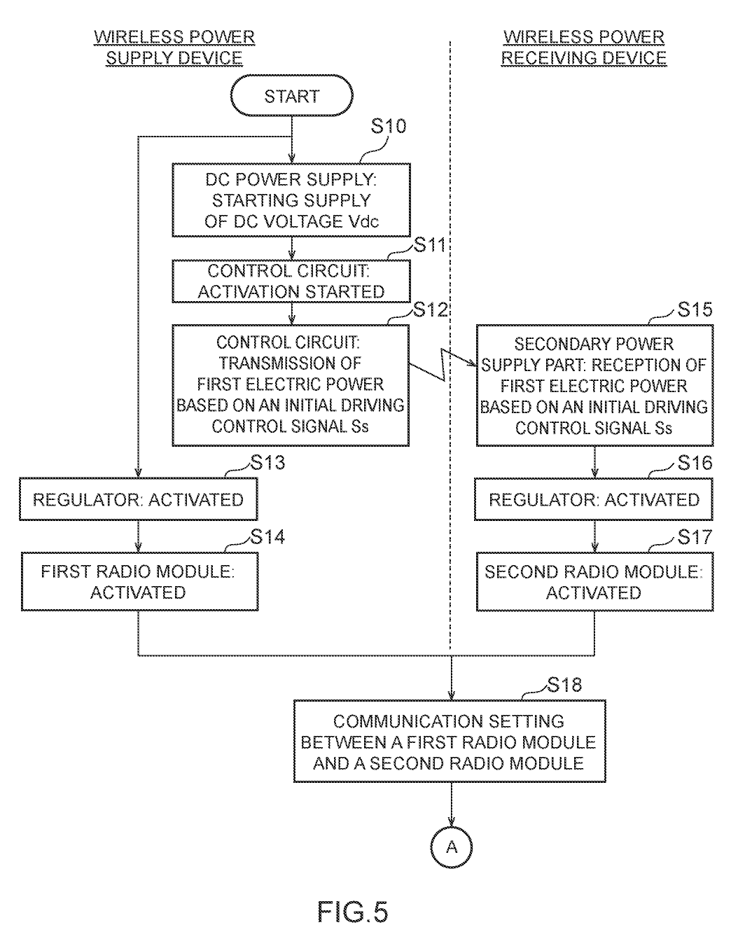

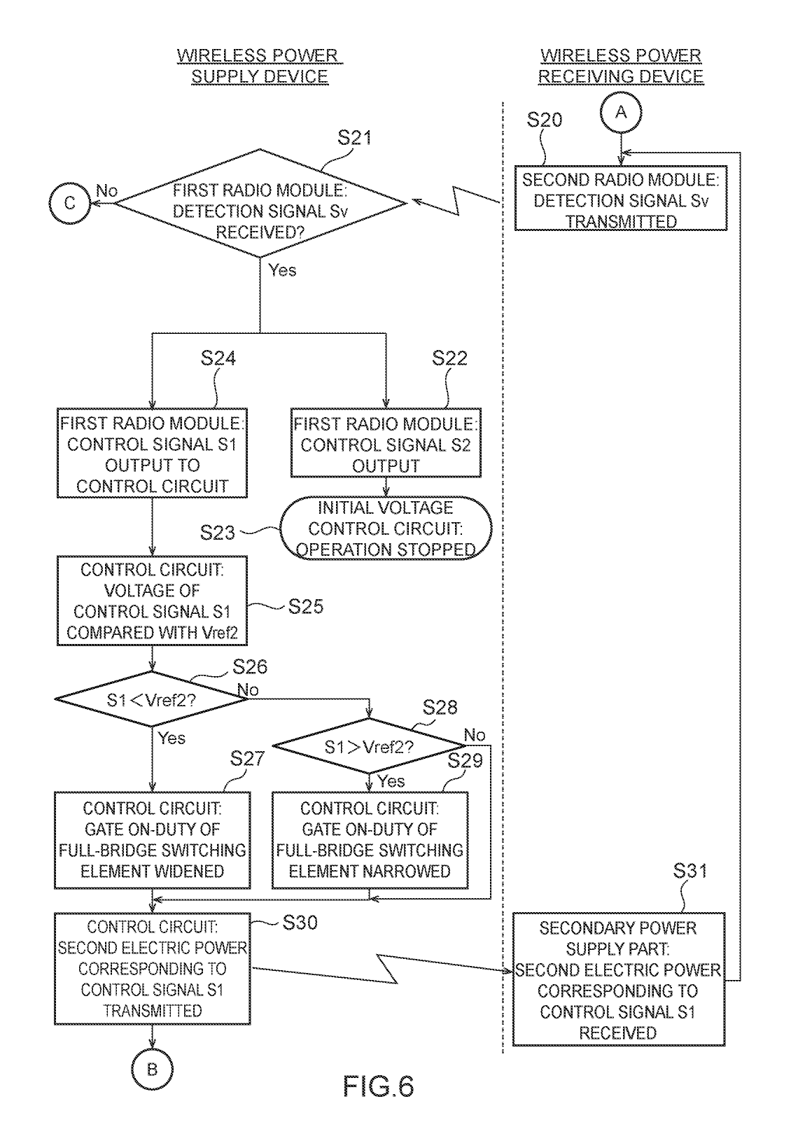

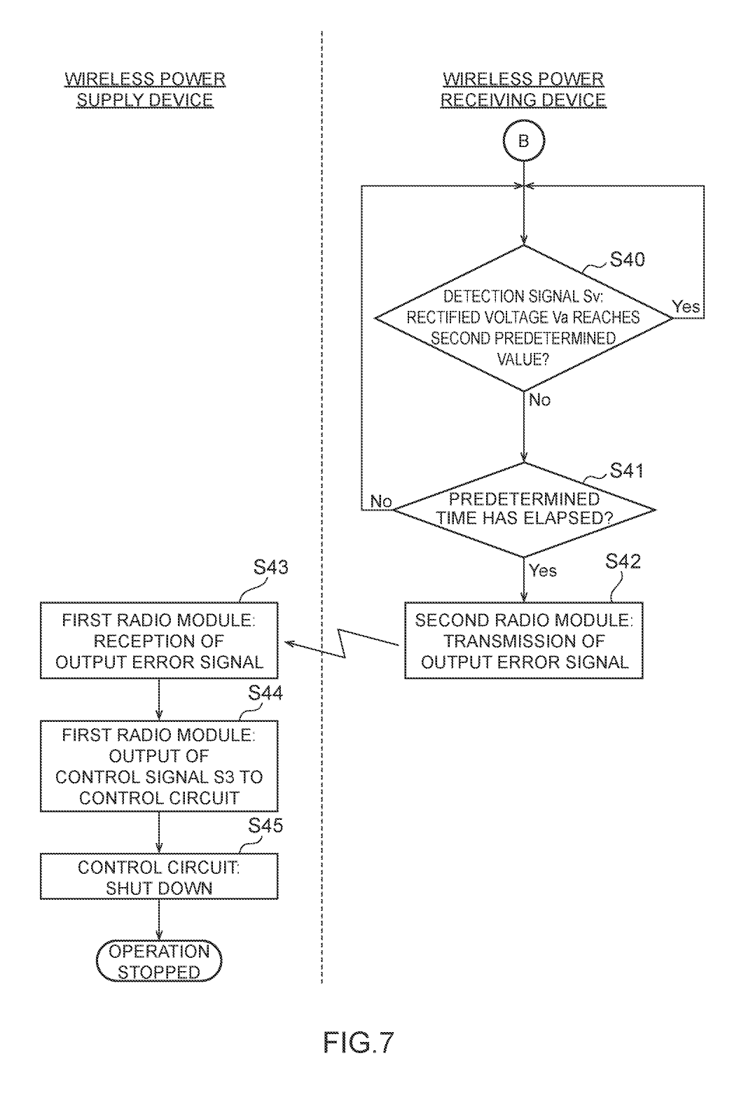

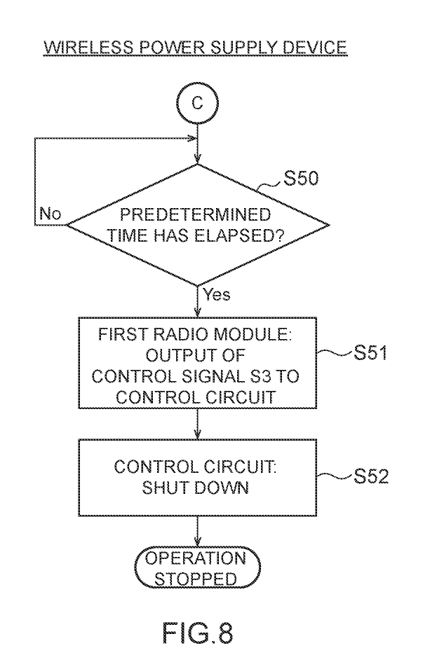

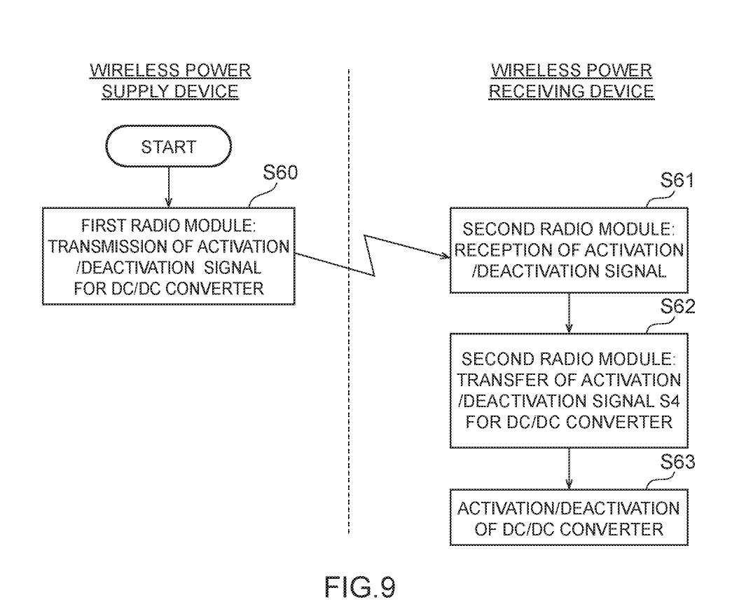

FIG. 5 is a flowchart showing operation until communication setting of the first radio module M1 and the second radio module M2 is established, and FIG. 6 is a flowchart showing operation of the electric power adjustment. FIG. 7 is a flowchart showing operation at the time of occurrence of output voltage abnormality, and FIG. 8 is a flowchart showing operation at the time of occurrence of a communication path establishment error between radio modules. FIG. 9 is a flowchart showing control operation of the DC/DC converter 23.

As shown in FIG. 5, in the wireless power supply device 1, the DC power supply 18 starts supplying DC voltage Vdc to the respective parts (step S10). In this manner, the regulator Re1 is activated (step S13), the supply of electric power of the driving voltage V1 is started, and the first radio module M1 is activated (step S14). Further, the control circuit 11 starts to be activated (step S11) and transmits first electric power corresponding to the initial driving control signal Ss by the driving circuit 12 and the power supply coil L1 (step S12).

Then, the first electric power corresponding to this initial driving control signal Ss is received by the secondary power supply part 28 of the wireless power receiving device 2 (step S15). In this manner, the regulator Re2 is activated (step S16), the supply of electric power of the driving voltage V2 is started, and the second radio module M2 is activated (step S17).

Next, the first radio module M1 and the second radio module M2 mutually perform communication setting between (step S18) and, after this, the electric power adjustment shown in FIG. 6 is carried out.

FIG. 6 is a flowchart showing operation of the electric power adjustment. In step S15, the secondary power supply part 28 supplies electric power of the rectified voltage Va, and therefore a detection voltage V3, which is obtained by dividing the rectified voltage Va by the voltage dividing resistors R3 and R4, is applied to the second radio module M2 of the wireless power receiving device 2. The second radio module M2 measures this detection voltage V3, generates the detection signal Sv as the rectified voltage information regarding the rectified voltage Va, and transmits this detection signal Sv by a radio communication path (step S20).

When this detection signal Sv is received by the first radio module M1 of the wireless power supply device 1 via a radio communication path (step S21:Yes), the control signal (second control signal) S2 is output to the initial voltage setting release circuit 15 (step S22). In this manner, the initial voltage control circuit 13 stops its operation (step S23). At the same time, the first radio module M1 outputs the control signal (first control signal) S1 based on this detection signal Sv to the control circuit 11 (step S24).

The control circuit 11 compares voltage of the control signal S1 with the reference voltage Vref2 of the operational amplifier 113 (step S25). Then, if the control signal S1 is smaller than the reference voltage Vref2 of the operational amplifier 113 (step S26:Yes), the control circuit 11 widens a gate on duty of the full-bridge switching element on the basis of this potential difference (step S27). If the control signal S1 is larger than the reference voltage Vref2 of the operational amplifier 113 (step S28: Yes), the control circuit 11 narrows a gate on duty of the full-bridge switching element on the basis of this potential difference (step S29). If the control signal S1 is equal to the reference voltage Vref2 of the operational amplifier 113 (step S28: No), the process proceeds to step S 30 to transmit second electric power corresponding to the control signal S1. In this manner, the wireless power transmission system S executes feedback control, so that the voltage of the control signal S1 is approximate to the reference voltage Vref2 of the operational amplifier 113.

After the processing in steps S27 and S29, the control circuit 11 transmits second electric power corresponding to the control signal S1 by the driving circuit 12 and the power supply coil L1 (step S30). The second electric power corresponding to the transmitted control signal S1 is received by the secondary power supply part 28 of the wireless power receiving device 2 (step S31), and the process returns to the processing in step S20. In this manner, the rectified voltage Va generated by the secondary power supply part 28 is feedback-controlled so that it reaches a predetermined value (second predetermined voltage Va2; for example 12V).

FIG. 7 is a flowchart showing processing at the time of output voltage abnormality. This processing is executed after step S30 in FIG. 6.

By the detection signal Sv, the second radio module M2 of the wireless power receiving device 2 determines whether or not the rectified voltage Va is a value approximate to the second predetermined voltage Va2 (step S40). If the rectified voltage Va exceeds the second predetermined voltage Va2 by at least a predetermined value (e.g. at least 24V) or is less than a predetermined value of the second predetermined voltage Va2 (e.g. less than 5V), the second radio module M2 determines that the output voltage is in an abnormal state and determines whether or not this state continues over a predetermined time (step S41).

If the second predetermined voltage Va2 is exceeded by at least a predetermined value or the state of less than the predetermined value of the second predetermined voltage, Va2 continues over a predetermined time (step S41: Yes), the second radio module M2 transmits an output error signal to the first radio module M1 (step S42). When receiving this output error signal (step S43), the first radio module M1 outputs the control signal S3 to the terminal SD of the control circuit 11 (step S44). In this manner, the control circuit 11 is shut down (step S45) and the wireless power supply device 1 stops transmitting electric power.

FIG. 8 is a flowchart showing processing in a case where an error occurs in establishing communication path between radio modules. This processing is executed when, in step S21 of FIG. 6, the first radio module M1 does not receive the detection signal Sv (step S21: No).

The first radio module M1 of the wireless power supply device 1 repeats this determination, unless a predetermined time has elapsed (step S50: No). On the other hand, the first radio module M1 outputs the control signal S3 to the terminal SD of the control circuit 11 (step S51), if a predetermined time has elapsed (step S50: Yes). In this manner, the control circuit 11 is shut down (step S52) and the wireless power supply device 1 stops transmitting electric power.

FIG. 9 is a flowchart showing control operation of the DC/DC converter 23.

The first radio module M1 of the wireless power supply device 1 receives an instruction from e.g. a non-illustrated upper device and transmits an activation signal or a deactivation signal for the DC/DC converter 23 (step S60).

When the second radio module M2 of the wireless power receiving device 2 receives this activation signal or deactivation signal (step S61), the second radio module M2 outputs the control signal S 4 instructing activation/deactivation to the DC/DC converter 23 (step S62). In this manner, the DC/DC converter 23 activates or deactivates (step S63).

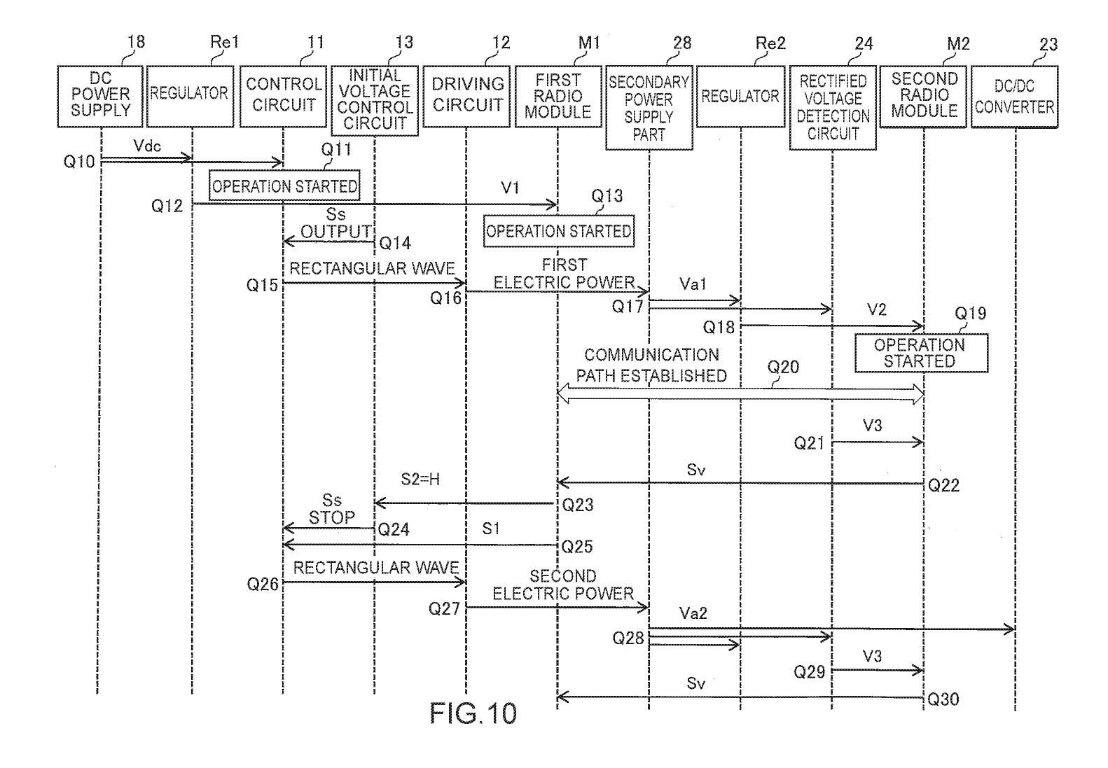

FIG. 10 is a sequence diagram showing from starting to electric power adjustment and shows one example of operation by means of flowcharts in FIGS. 5 and 6.

The magnetic field coupling type wireless power transmission system S is activated, and the DC power supply 18 starts supplying electric power of the DC voltage Vdc to the regulator Re1, the control circuit 11, etc (sequence Q10). In this manner, the control circuit 11 starts operation (sequence Q11), and the regulator Re1 converts the DC voltage Vdc to the driving voltage V1 to supply it to the first radio module M1 (sequence Q12) and to activate the first radio module M1 (sequence Q13). The control circuit 11 generates electric power of the constant voltage Vreg and supplies it to the initial voltage control circuit 13. The initial voltage control circuit 13 applies, as the initial driving control signal Ss, the voltage divided by the voltage dividing resistors R1 and R2 of the initial voltage setting circuit 14, to the terminal FB1 of the control circuit 11 (sequence Q14). This initial driving control signal Ss is set beforehand, so that the rectified voltage Va output from the secondary power supply part 28 of the wireless power receiving device 2 reaches the first predetermined voltage Va1 (e.g. 5V).

The control circuit 11 outputs rectangular waves of pulse widths (on-duty) of the periods T1 and T2, thereby to control the driving circuit 12 (sequence Q15). The driving circuit 12 having the full-bridge configuration drives the power supply coil L1 by a rectangular wave of a resonant frequency on the power receiving side, thereby to transmit electric power (sequence Q16). The driving frequency of this rectangular wave is set to a fixed frequency between the parallel resonant frequency fp and the series resonant frequency fs when the distance between the power supply coil L1 and the power receiving coil L2 is set within a predetermined range, so that the power transmission efficiency can be enhanced. Further, the ON times of the pulse voltage that drives the power supply coil L1 are symmetrical as shown in FIGS. 4(b) to 4(f).

The secondary power supply part 28 generates resonant voltage by means of the resonant circuit 21 including the power receiving coil L2 for receiving wireless electric power and the resonant capacitor C1, while it generates the rectified voltage Va by rectifying this resonant voltage by means of a diode bridge DB. The electric power of this rectified voltage Va is the first predetermined voltage Va1 (e.g. 5V) and is supplied to the regulator Re2 and the rectified voltage detection circuit 24 (sequence Q17). The rectified voltage Va is applied to the DC/DC converter 23 as well, while this DC/DC converter 23 does not operate with 5V and is not illustrated in the figure.

The regulator Re2 converts electric power of the first predetermined voltage Va1 to electric power of the driving voltage V2 to supply it to the second radio module M2 (sequence Q18) and to activate the second radio module M2 (sequence Q19). The first radio module M1 is set in the state of mutual communication with the second radio module M2 to establish the radio communication path (sequence Q20).

The following operation is carried out, so that the rectified voltage Va reaches the second predetermined voltage Va2 (e.g. 12V).

The rectified voltage detection circuit 24 generates the detection voltage V3 obtained by dividing the rectified voltage Va by the voltage dividing resistors R3 and R4 (sequence Q21). This detection voltage V3 is measured by the signal information processing circuit 27 (microcomputer) of the second radio module M2, and the detection signal Sv is generated. The detection signal Sv being the rectified voltage information regarding the rectified voltage Va is transmitted to the first radio module M1 as a feedback signal (sequence Q22).

When this detection signal Sv is received by the first radio module M1 by means of the radio signal transmission-reception circuit 16, the control signal S2 in the High (H) level is output to the initial voltage control circuit 13 (sequence Q23). The control signal S2 in the High level is applied to the base of the transistor Q5 of the initial voltage setting release circuit 15 to turn on the transistor Q5, so that the terminal FB1 of the control circuit 11 is set to the Low level. Therefore, the initial voltage control circuit 13 stops outputting the initial driving control signal Ss to the control circuit 11 (sequence Q24).

At the same time, the first radio module M1 generates the control signal S1 based on the detection signal Sv and outputs (feeds back) the control signal S1 to the terminal FB2 of the control circuit 11 (sequence Q25). The control circuit 11 outputs rectangular waves of pulse widths (on-duty) decided on the basis of the result of comparison between the control signal S1 and the reference voltage Vref2 of the operational amplifier 113, thereby to control the driving circuit 12 (sequence Q26). The driving circuit 12 having the full-bridge configuration drives the power supply coil L1 by a rectangular wave of a resonant frequency on the power receiving side, thereby to transmit electric power (sequence Q27). This resonant frequency is, for example, 100 kHz.

The secondary power supply part 28 generates resonant voltage by the resonant circuit 21 including the power receiving coil L2 and the resonant capacitor C1, while it generates the rectified voltage Va by rectifying this resonant voltage by means of a diode bridge DB. The electric power of this rectified voltage Va is the second predetermined voltage Va2 (e.g. 12V) and is supplied to the regulator Re2, the rectified voltage detection circuit 24 and the DC/DC converter 23 (sequence Q28). After this, the DC/DC converter 23 is put into the state where it can be activated by the control signal S4.

The rectified voltage detection circuit 24 generates the detection voltage V3 obtained by dividing the rectified voltage Va by the voltage dividing resistors R3 and R4 (sequence Q29). This detection voltage V3 is measured by the signal information processing circuit 27 (microcomputer) of the second radio module M2, and the detection signal Sv is generated. The detection signal Sv being the rectified voltage information regarding the rectified voltage Va is transmitted to the first radio module M1 as a feedback signal (sequence Q30).

After this, the processing of sequences Q25 to Q30 is repeated, and the rectified voltage Va is converged at the second predetermined voltage Va2 (e.g. 12V).

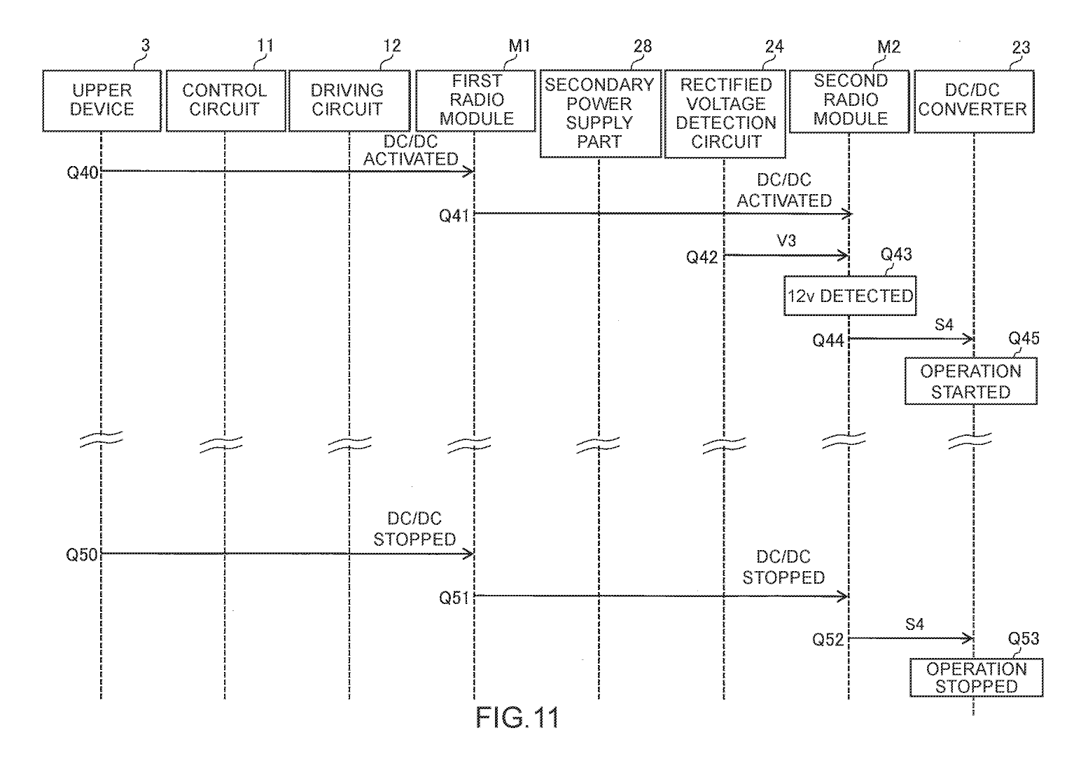

FIG. 11 is a sequence diagram showing control operation of the DC/DC converter 23 controlled by the upper device 3.

When the wireless power transmission system S is activated, the upper device 3 transmits an activation signal for the DC/DC converter 23 to the first radio module M1 (sequence Q40).

This first radio module M1 transfers the activation signal for the DC/DC converter 23 to the second radio module M2 of the wireless power receiving device 2 (sequence Q41). Further, the rectified voltage detection circuit 24 applies the detection voltage V3 to the second radio module M2 (sequence Q42). If the second radio module M2 detects that the rectified voltage Va reaches 12V being the second predetermined voltage Va2 (sequence Q43), the control signal S4 is output to the DC/DC converter 23 (sequence Q44) to activate the DC/DC converter 23 (sequence Q45). After this, the DC/DC converter 23 supplies electric power of predetermined voltage (e.g. the output voltage Vout) to the load 29 (see FIG. 1).

Even if, after sequence Q45, the consumption power of the DC/DC converter 23 and the load 29 vary, the detection signal Sv is fed back from the second radio module M2 to the first radio module M1 and the control signal S1 based on the detection signal Sv is fed back to the control circuit 11, so that the rectified voltage Va reaches the second predetermined voltage Va2. Due to this, the on-duty of the pulse signal output from the driving circuit 12 for driving the power supply coil L1 changes.

When the wireless power transmission system S stops, the upper device 3 transmits a deactivation signal for the DC/DC converter 23 to the first radio module M1 (sequence Q50).

This first radio module M1 transfers the deactivation signal for the DC/DC converter 23 to the second radio module M2 of the wireless power receiving device 2 (sequence Q51). The second radio module M2 outputs the control signal S4 to the DC/DC converter 23 (sequence Q52) to deactivate this DC/DC converter 23 (sequence Q53).

Further, by turning off the DC voltage Vdc on the power supply side, the wireless power supply device 1 may be deactivated in a one-sided manner.

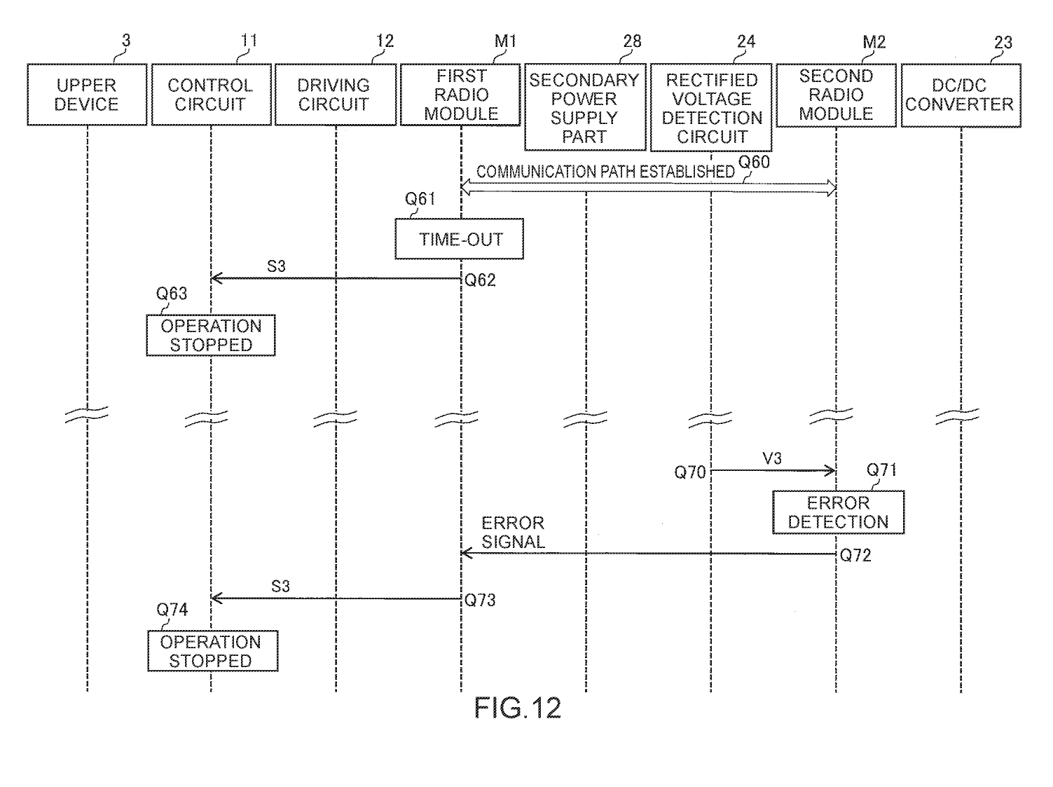

FIG. 12 is a sequence diagram showing operation at the time of occurrence of an error and shows one example of operation by means of flowcharts in FIGS. 7 and 8.

The first radio module M1 is set in the state of mutual communication with the second radio module M2 to try to establish the communication path (sequence Q60).

After this, when the first radio module M1 senses time-out where the communication path is not established (sequence Q61), the first radio module M1 outputs the control signal S3 to the terminal SD of the control circuit 11 (sequence Q62). In this manner, the control circuit 11 stops operation (sequence Q63) and the wireless power supply device 1 stops transmitting electric power. In this manner, the wireless power transmission system S can be stopped.

After the radio communication path between the first radio module M1 and the second radio module M2 is established, if the radio communication path is disconnected for some reason, the first radio module M1 outputs the control signal S3 to the terminal SD of the control circuit 11 in the same way as described above, thereby to be capable of stopping the wireless power transmission system S.

Further, a case is considered where an abnormal state, in which the rectified voltage Va of the wireless power receiving device 2 reaches a value exceeding the second predetermined voltage Va2 or a value less than the second predetermined voltage Va2, continues for a predetermined time. The rectified voltage detection circuit 24 generates the detection voltage V3 obtained by dividing the rectified voltage Va by the voltage dividing resistors R3 and R4. This detection voltage V3 is applied to the signal information processing circuit 27 (microcomputer) of the second radio module M2 (sequence Q70).

The second radio module M2 senses an error of the rectified voltage Va (sequence Q71) and transmits the error signal to the first radio module M1 (sequence Q72). When receiving this error signal, the first radio module M1 outputs the control signal S3 to the terminal SD of the control circuit 11 (sequence Q73). In this manner, the control circuit 11 stops operation (sequence Q74) and the wireless power supply device 1 stops transmitting electric power. In this manner, for example, when the wireless power supply device 1 and the wireless power receiving device 2 are spaced farther apart than expected, the wireless power transmission system S can be stopped.

As described above, the wireless power transmission system S according to the present disclosure does not need a resonant circuit on the power supply side and therefore it is not necessary to make power supply side resonance and power receiving side resonance coincide with each other as in a conventional magnetic field resonance type. Further, it is not necessary to make a frequency follow deviation of the positions of the power supply coil and the power receiving coil as well as variation of the distance between these coils, so that a resonant frequency does not need to be controlled.

### (Variations)

The present disclosure is not limited to the above embodiment and can vary and be embodied, as long as it does not deviate from the purpose of the present disclosure, as described in (a) to (e) below.

(a) In the wireless power receiving device 2, the DC/DC converter 23 is not indispensable and the load 29 may be directly connected to the device 2.

(b) The object to be controlled by the upper device 3 of the wireless power supply device 1 is not limited to the DC/DC converter 23 and, for example, the load 29 may be controlled.

(c) The radio communication between the wireless power supply device 1 and the wireless power receiving device 2 is not limited to the radio wave communication, and the wireless systems such as infrared communication, visible light communication, and ultrasonic communication method may be used if a proper radio communication path can be established.

(d) The feedback control is not limited to the proportional control (classic control) shown in FIG. 6, and the classic control such as PI control and PID control as well as the modern control may be used.

(e) The driving circuit 12 of the wireless power supply device 1 is not limited to full-bridge configuration, and half-bridge configuration may be adopted.

What is claimed is:

1. A wireless power supply device comprising:
a power supply coil for wirelessly transmitting electric power to a power receiving device;
a driving circuit for outputting pulse electric power to the power supply coil;
a first radio module for receiving rectified voltage information regarding rectified voltage generated in the power receiving device via a radio communication path; and
a control circuit for generating a driving control signal on the basis of the rectified voltage information received by the first radio module, thereby to control the driving circuit, said control circuit controlling a driving frequency of the driving circuit at a fixed frequency between a series resonant frequency and a parallel resonant frequency of a resonant circuit of the power receiving device.

2. The wireless power supply device according to claim 1, wherein
the driving circuit is a bridge circuit and applies the pulse electric power to the power supply coil to pulse-drive the coil, and
the control circuit variably controls an on-duty of the pulse electric power on the basis of the rectified voltage information.

3. The wireless power supply device according to claim 2, wherein
the driving circuit is a full-bridge circuit, and the pulse widths of gate signals are equal between high-side switching elements and between low-side switching elements of the driving circuit.

4. A wireless power receiving device, comprising:
a resonant circuit for generating resonant voltage, including a power receiving coil for wirelessly receiving electric power from a power supply device and a resonant capacitor;
a rectifying circuit for rectifying the resonant voltage to output rectified voltage; and
a second radio module for generating rectified voltage information on the basis of the rectified voltage and transmitting the information to a first radio module of the power supply device; wherein
a resonant frequency of the resonant circuit is set to be a frequency between a series resonant frequency and a parallel resonant frequency of the resonant circuit by the power supply device.

5. The wireless power receiving device according to claim 4, wherein:
the resonant circuit is configured in such a manner that the power receiving coil and the resonant capacitor are connected in parallel;
the series resonant frequency is determined on the basis of a leakage inductance of a secondary side of a transformer and a capacitance of the resonant capacitor, the transformer consisting of a power supply coil of the power supply device and the power receiving coil; and
the parallel resonant frequency is determined on the basis of a self-inductance of the power receiving coil and the capacitance of the resonant capacitor.

6. The power receiving device according to claim 4, further comprising a load which operates by application of second predetermined voltage higher than the first predetermined voltage, with which the second radio module can operate, wherein
the load is activated or deactivated by a control signal output by the second radio module.

7. A wireless power transmission system, comprising
a wireless power supply device according to claim 1 and a wireless power receiving device, comprising:
a resonant circuit for generating resonant voltage, including a power receiving coil for wirelessly receiving electric power from a power supply device and a resonant capacitor;
a rectifying circuit for rectifying the resonant voltage to output rectified voltage; and
a second radio module for generating rectified voltage information on the basis of the rectified voltage and transmitting the information to a first radio module of the power supply device; wherein
a resonant frequency of the resonant circuit is set to be a frequency between a series resonant frequency and a parallel resonant frequency of the resonant circuit by the power supply device.
